(19) United States
(12) Patent Application Publication
(10) Pub. No.: US 2025/0199873 A1
(43) Pub. Date: Jun. 19, 2025

(54) AUTOMATICALLY DETECTING CLOUD COMPUTING PLATFORM-RELATED ANOMALIES

(71) Applicant: Dell Products L.P., Round Rock, TX (US)

(72) Inventors: Gandhirajan N, Bangalore (IN); Geetha Venkatesan, Bangalore (IN); Sabu K. Syed, Austin, TX (US); Sunil Kumar Patra, Bengaluru (IN)

(21) Appl. No.: 18/539,882

(22) Filed: Dec. 14, 2023

(51) Int. Cl. G06F 9/50

(52) U.S. Cl. CPC G06F 9/5077; G06F 9/5072

(57) ABSTRACT

Methods, apparatus, and processor-readable storage media for automatically detecting cloud computing platform-related anomalies are provided herein. An example computer-implemented method includes identifying a modification to at least one resource-related value associated with a cloud computing platform by processing data related to the at least one resource-related value in connection with at least one temporal period; processing multiple forms of cloud computing platform-related parameter data in connection with the temporal period(s); determining, based on the processing of the cloud computing platform-related parameter data, that no related modification corresponding to the identified modification to the at least one resource-related value has occurred in the temporal period(s) with respect to cloud computing platform-related parameter(s) associated with the cloud computing platform-related parameter data; and performing automated action(s) based on determining that no related modification corresponding to the identified modification has occurred with respect to the cloud computing platform-related parameter(s).

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

Anomalies associated with cloud computing platforms can result in numerous negative consequences such as, for example, resource and/or performance issues for the cloud computing platforms, and increased costs for the end users of the cloud computing platforms. However, conventional cloud computing platform management approaches are typically reactive in nature, identifying and responding to negative consequences after such consequences have occurred.

### SUMMARY

Illustrative embodiments of the disclosure provide techniques for automatically detecting cloud computing platform-related anomalies.

An exemplary computer-implemented method includes identifying a modification to at least one resource-related value associated with a cloud computing platform by processing data related to the at least one resource-related value in connection with at least one temporal period, and processing multiple forms of cloud computing platform-related parameter data in connection with the at least one temporal period. The method also includes determining, based at least in part on the processing of the multiple forms of cloud computing platform-related parameter data, that no related modification corresponding to the identified modification to the at least one resource-related value has occurred in the at least one temporal period with respect to one or more cloud computing platform-related parameters associated with the multiple forms of cloud computing platform-related parameter data. Further, the method additionally includes performing one or more automated actions based at least in part on determining that no related modification corresponding to the identified modification to the at least one resource-related value has occurred in the at least one temporal period with respect to the one or more cloud computing platform-related parameters.

Illustrative embodiments can provide significant advantages relative to conventional cloud computing platform management approaches. For example, problems with reactive approaches are overcome in one or more embodiments through automatically detecting anomalous modifications to resource-related values for a cloud computing platform before associated negative consequences arise.

These and other illustrative embodiments described herein include, without limitation, methods, apparatus, systems, and computer program products comprising processor-readable storage media.

### BRIEF DESCRIPTION OF THE DRAWINGS

FIG. 1 shows an information processing system configured for automatically detecting cloud computing platform-related anomalies in an illustrative embodiment.

FIG. 2 shows an example architecture and workflow associated with automatically detecting cloud computing platform-related anomalies in an illustrative embodiment.

FIG. 3 shows example pseudocode for extracting data from activity logs in an illustrative embodiment.

FIG. 4 shows example pseudocode for fetching cloud computing platform resource-related value details in an illustrative embodiment.

FIG. 5 is a flow diagram of a process for automatically detecting cloud computing platform-related anomalies in an illustrative embodiment.

FIGS. 6 and 7 show examples of processing platforms that may be utilized to implement at least a portion of an information processing system in illustrative embodiments.

### DETAILED DESCRIPTION

Illustrative embodiments will be described herein with reference to exemplary computer networks and associated computers, servers, network devices or other types of processing devices. It is to be appreciated, however, that these and other embodiments are not restricted to use with the particular illustrative network and device configurations shown. Accordingly, the term “computer network” as used herein is intended to be broadly construed, so as to encompass, for example, any system comprising multiple networked processing devices.

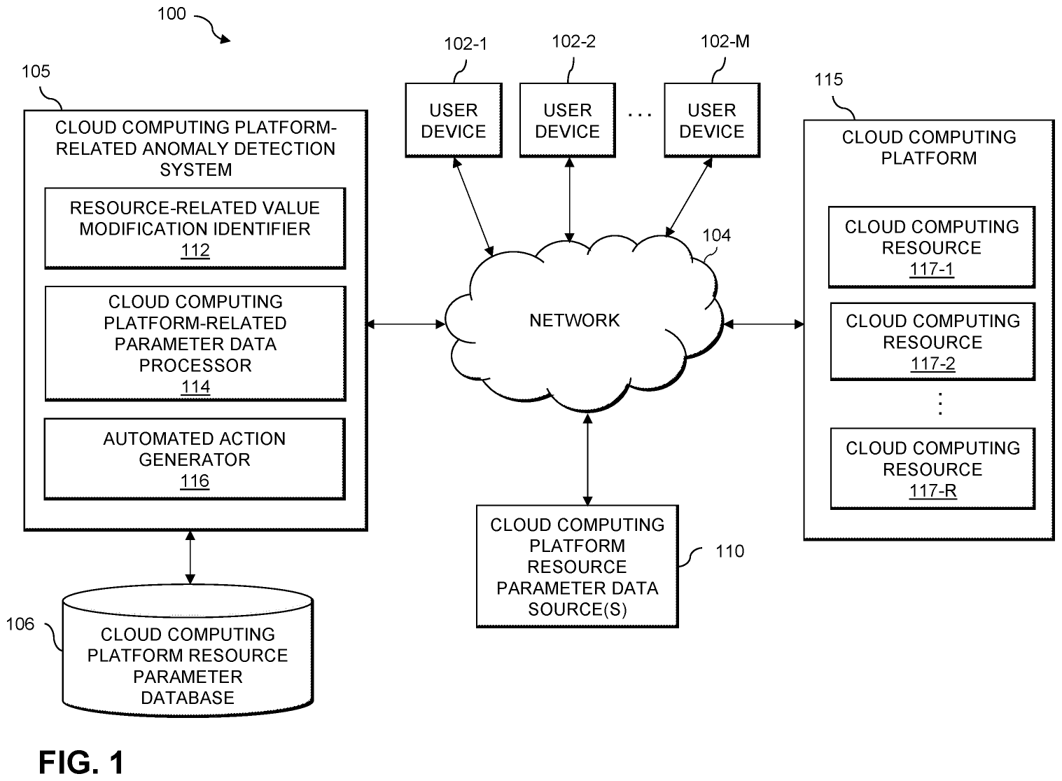

FIG. 1 shows a computer network (also referred to herein as an information processing system) 100 configured in accordance with an illustrative embodiment. The computer network 100 comprises a plurality of user devices 102-1, 102-2, . . . 102-M, collectively referred to herein as user devices 102. The user devices 102 are coupled to a network 104, where the network 104 in this embodiment is assumed to represent a sub-network or other related portion of the larger computer network 100. Accordingly, elements 100 and 104 are both referred to herein as examples of “networks” but the latter is assumed to be a component of the former in the context of the FIG. 1 embodiment. Also coupled to network 104 is cloud computing platform-related anomaly detection system 105, cloud computing platform resource parameter data source(s) 110, and cloud computing platform 115.

As further detailed herein, cloud computing platform 115 includes a plurality of cloud computing resources 117-1, 117-2, . . . 117-R, collectively referred to herein as cloud computing resources 117. In one or more example embodiments, such cloud computing resources 117 can include relational database management system(s), application programming interface (API) management system(s), virtual machine and/or container orchestration system(s), cloud-based data engineering tool(s), blob storage, cloud native data streaming system(s), etc. Additionally, cloud computing platform resource parameter data source(s) 110 can include data sources pertaining, for example, to application deployment data, resource configuration data, incoming request volume-related data, etc.

The user devices 102 may comprise, for example, mobile telephones, laptop computers, tablet computers, desktop computers or other types of computing devices. Such devices are examples of what are more generally referred to herein as “processing devices.” Some of these processing devices are also generally referred to herein as “computers.”

The user devices 102 in some embodiments comprise respective computers associated with a particular company, organization or other enterprise. In addition, at least portions of the computer network 100 may also be referred to herein as collectively comprising an “enterprise network.” Numerous other operating scenarios involving a wide variety of different types and arrangements of processing devices and networks are possible, as will be appreciated by those skilled in the art.

Also, it is to be appreciated that the term “user” in this context and elsewhere herein is intended to be broadly construed so as to encompass, for example, human, hardware, software or firmware entities, as well as various combinations of such entities.

The network 104 is assumed to comprise a portion of a global computer network such as the Internet, although other types of networks can be part of the computer network 100, including a wide area network (WAN), a local area network (LAN), a satellite network, a telephone or cable network, a cellular network, a wireless network such as a Wi-Fi or WiMAX network, or various portions or combinations of these and other types of networks. The computer network 100 in some embodiments therefore comprises combinations of multiple different types of networks, each comprising processing devices configured to communicate using internet protocol (IP) or other related communication protocols.

Additionally, cloud computing platform-related anomaly detection system 105 can have an associated cloud computing platform resource parameter database 106 configured to store data pertaining to parameters such as, for example, costs associated with application programming interface management services serverless structured query language databases, application monitoring services, etc.

The cloud computing platform resource parameter database 106 in the present embodiment is implemented using one or more storage systems associated with cloud computing platform-related anomaly detection system 105. Such storage systems can comprise any of a variety of different types of storage including network-attached storage (NAS), storage area networks (SANs), direct-attached storage (DAS) and distributed DAS, as well as combinations of these and other storage types, including software-defined storage.

Also associated with cloud computing platform-related anomaly detection system 105 are one or more input-output devices, which illustratively comprise keyboards, displays or other types of input-output devices in any combination. Such input-output devices can be used, for example, to support one or more user interfaces to cloud computing platform-related anomaly detection system 105, as well as to support communication between cloud computing platform-related anomaly detection system 105 and other related systems and devices not explicitly shown.

Additionally, cloud computing platform-related anomaly detection system 105 in the FIG. 1 embodiment is assumed to be implemented using at least one processing device. Each such processing device generally comprises at least one processor and an associated memory, and implements one or more functional modules for controlling certain features of the cloud computing platform-related anomaly detection system 105.

More particularly, cloud computing platform-related anomaly detection system 105 in this embodiment can comprise a processor coupled to a memory and a network interface.

The processor illustratively comprises a microprocessor, a central processing unit (CPU), a graphics processing unit (GPU), a tensor processing unit (TPU), a microcontroller, an application-specific integrated circuit (ASIC), a field-programmable gate array (FPGA) or other type of processing circuitry, as well as portions or combinations of such circuitry elements.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage disk, a storage array or an integrated circuit containing memory, as well as a wide variety of other types of computer program products. The term “article of manufacture” as used herein should be understood to exclude transitory, propagating signals. These and other references to “disks” herein are intended to refer generally to storage devices, including solid-state drives (SSDs), and should therefore not be viewed as limited in any way to spinning magnetic media.

The network interface allows the cloud computing platform-related anomaly detection system 105 to communicate over the network 104 with the user devices 102, and illustratively comprises one or more conventional transceivers.

The cloud computing platform-related anomaly detection system 105 further comprises resource-related value modification identifier 112, cloud computing platform-related parameter data processor 114, and automated action generator 116.

It is to be appreciated that this particular arrangement of elements 112, 114 and 116 illustrated in the cloud computing platform-related anomaly detection system 105 of the FIG. 1 embodiment is presented by way of example only, and alternative arrangements can be used in other embodiments. For example, the functionality associated with elements 112, 114 and 116 in other embodiments can be combined into a single module, or separated across a larger number of modules. As another example, multiple distinct processors can be used to implement different ones of elements 112, 114 and 116 or portions thereof.

At least portions of elements 112, 114 and 116 may be implemented at least in part in the form of software that is stored in memory and executed by a processor.

It is to be understood that the particular set of elements shown in FIG. 1 for automatically detecting cloud computing platform-related anomalies involving user devices 102 of computer network 100 is presented by way of illustrative example only, and in other embodiments additional or alternative elements may be used. Thus, another embodiment includes additional or alternative systems, devices and other network entities, as well as different arrangements of modules and other components. For example, in at least one embodiment, two or more of cloud computing platform-related anomaly detection system 105, cloud computing platform resource parameter database 106, cloud computing platform 115, and cloud computing platform resource parameter data source(s) 110 can be on and/or part of the same processing platform.

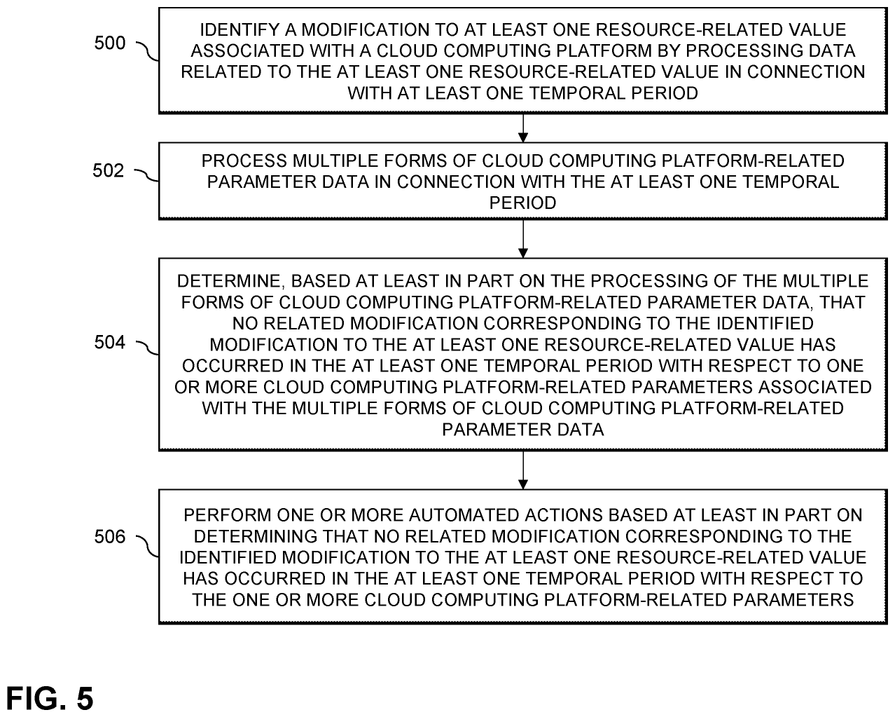

An exemplary process utilizing elements 112, 114 and 116 of an example cloud computing platform-related anomaly detection system 105 in computer network 100 will be described in more detail with reference to the flow diagram of FIG. 5.

Accordingly, at least one embodiment includes automatically detecting cloud computing platform-related anomalies. By way of example, such an embodiment can include automatically identifying one or more cloud computing platform cost anomalies and detecting, based at least in part on the one or more identified cloud computing platform cost anomalies, one or more underlying issues associated with the corresponding cloud provider platform. Accordingly, such an embodiment includes implementing an automated solution to identify abnormal cost deviations for at least one resource in a given cloud provider platform which are distinct and/or separate from changes made to one or more cloud-related parameters (such as, for example, application deployment, incoming request volume, resource configurations, etc.).

Additionally, one or more embodiments include generating and outputting one or more alerts to the corresponding cloud provider regarding one or more potential underlying anomalies with respect, for instance, to the quantification and charging of cloud resources. By way merely of example, such an embodiment can include identifying a cost increase associated with a given cloud computing platform resource, and determining that no significant corresponding changes have been made to dependent and/or related cloud computing platform resource parameters. An alert can then be generated, detailing the identified cost increase and lack of corresponding parameter change, and output to the provider associated with the cloud computing platform. Accordingly, such an embodiment includes facilitating proactive detection and remediation of one or more cloud computing platform-related issues, which can preclude resource-intensive efforts (e.g., user refunds), improve the stability of underlying cloud computing platform resources, and/or improve end user experience.

At least one embodiment can also include leveraging information related to any detected cloud computing platform-related anomaly to determine and/or predict one or more underlying issues associated with the cloud computing platform. By way of example, when a sudden cost increase is observed for a given resource, at least one embodiment includes searching for any change in one or more dependent baseline parameters (e.g., resource configuration details, application deployment history on the resource, incoming request volume to the resource, etc.) to determine an underlying issue. When there is no noteworthy and/or significant change in the baseline parameters, then it is determined that the issue resides at and/or is derived from the cloud platform service, and a corresponding alert is triggered.

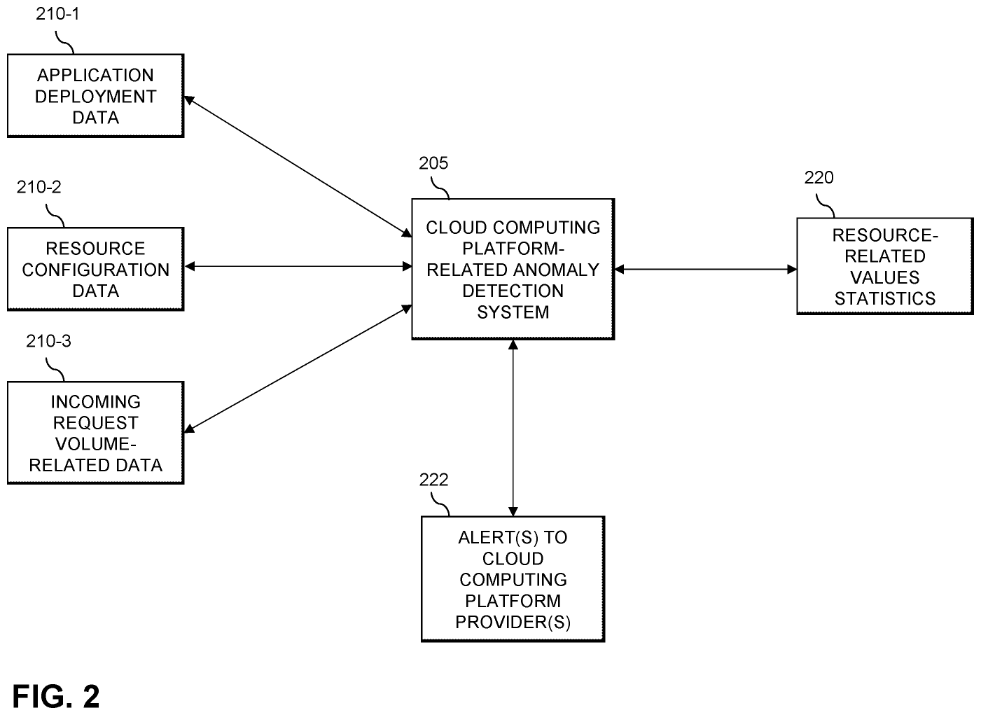

FIG. 2 shows an example architecture and workflow associated with automatically detecting cloud computing platform-related anomalies in an illustrative embodiment. By way of illustration, FIG. 2 depicts cloud computing platform-related anomaly detection system 205 obtaining resource-related values statistics 220, wherein the resource-related values are related to resources associated with at least one cloud computing platform, and processing at least a portion of the resource-related values statistics 220 to identify at least one resource-related value anomaly. Additionally, cloud computing platform-related anomaly detection system 205 analyzes data from sources including, for example, application deployment data 210-1, resource configuration data 210-2, and incoming request volume-related data 210-3. Such analysis attempts to identify one or more changes in the various data that might correspond to the at least one identified resource-related value anomaly. If the cloud computing platform-related anomaly detection system 205 determines, based at least in part on processing the various data, that no change in the various data corresponds to the at least one identified resource-related value anomaly, then the cloud computing platform-related anomaly detection system 205 generates and outputs at least one alert 222 to the at least one cloud computing platform provider associated with the at least one identified resource-related value anomaly.

By way merely of illustration, consider the following example embodiment detailed within the framework of FIG. 2. In such an example embodiment, cloud computing platform-related anomaly detection system 205 monitors resource-related values statistics 220 in the form of cost of a given cloud computing platform resource. Additionally, cloud computing platform-related anomaly detection system 205 monitors and/or analyzes data which can include, for example, the audit history of how the following parameters influence the cost of the given cloud computing platform resource: the incoming request volume, per a given temporal period, to the given cloud computing platform resource (e.g., as derived from incoming request volume-related data 210-3); application deployments and/or updates to the given cloud computing platform resource (e.g., as derived from application deployment data 210-1); and the configurations and specifications of the given cloud computing platform resource (e.g., as derived from resource configuration data 210-2).

When the cost for the given cloud computing platform resource exhibits an anomaly or unexpected change (e.g., when the cost spikes above an expected range or value), the cloud computing platform-related anomaly detection system 205 looks for any change in one or more dependent baseline parameters (e.g., derived from data 210-1, 210-2 and/or 210-3). If there is no such change to the dependent baseline parameters, the cloud computing platform-related anomaly detection system 205 generates and outputs an alert 222 to the provider of the given cloud computing platform, wherein the alert 222 includes resource details (e.g., subscription identifier, resource group, resource identifier for the resource on which a problem is detected, etc.) of the given cloud computing platform resource as well as portions of the audit history of the dependent baseline parameters. If there is a significant change in one or more dependent baseline parameters, then no alert is generated and data monitoring is resumed.

Such an alert 222 can assist the cloud computing platform provider in investigating one or more underlying issues in the respective resource which potentially resulted in the anomaly or unexpected change to the cost of the respective resource, as well as in rectifying such one or more underlying issues proactively. If, for example, such issue resolution is taking longer than anticipated and/or desired, then the potential problem can be identified in a notification to one or more end users of the cloud computing platform in advance. Such communication can help, for example, in maintaining and/or improving the user experience, as the end user would likely not need to spend time investigating the reason for an unexpected cost change with respect to the given cloud computing platform resource. Additionally or alternatively, after the issue resolution, the cloud computing platform provider can adjust the billing cost proactively, without any intervention from the end user, thereby avoiding resource-intensive refund process cycles and improving the user experience.

By way of further illustration, consider the following additional example implementations of the cloud computing platform-related anomaly detection system. One such example implementation involves an API management services issue, wherein an API management services offered by a cloud computing platform provider caused a sudden cost spike without any changes to the API management configuration. No new APIs were onboarded, and the incoming request volume remained consistent. The cost spike was related to a drastic increase in the capacity units consumed. Based at least in part on relevant data processing, the cloud computing platform-related anomaly detection system identified that the issue was due at least in part to a platform upgrade that caused the gateway services to crash due to high memory consumption, resulting in an increase of the capacity units. The cloud computing platform-related anomaly detection system then generated an alert detailing such determinations, and output the alert to the cloud computing platform provider, facilitating an efficient remediation of the platform upgrade issue and any necessary user refund (e.g., prior to the billing issue being raised by the user).

Another such example implementation involves a structured query language database (SQL DB) issue, wherein a serverless SQL DB offered by a cloud computing platform provider caused a sudden cost spike without any changes to the DB configuration. No new DB operations were introduced, and the incoming request volume remained consistent. The cost spike was related to a drastic increase in virtual Central Processing Unit (vCPU) consumption. Based at least in part on relevant data processing, the cloud computing platform-related anomaly detection system identified that the issue was due at least in part to a bug in the background version cleaner task in the SQL platform offering, which increased the buffer pool activity, causing high vCPU consumption. The cloud computing platform-related anomaly detection system then generated an alert detailing such determinations, and output the alert to the cloud computing platform provider, facilitating an efficient remediation of the platform bug issue and any necessary user refund (e.g., prior to the billing issue being raised by the user).

Yet another such example implementation involves an application monitoring issue, wherein application monitoring offered by a cloud computing platform provider caused a sudden cost spike without any changes to application monitoring configurations. No new application was onboarded to the application monitoring service, and the incoming request volume remained consistent. The cost spike was related to the consideration of additional tables for billing. Based at least in part on relevant data processing, the cloud computing platform-related anomaly detection system identified that the issue was due at least in part to a platform bug that excluded certain tables during billing, which resulted in the respective resource being under-billed. The cloud computing platform-related anomaly detection system then generated an alert detailing such determinations, and output the alert to the cloud computing platform provider, facilitating an efficient remediation of the platform bug issue and any necessary user refund (e.g., prior to the billing issue being raised by the user).

Accordingly, in such example implementations, the cloud computing platform-related anomaly detection system monitored such resource cost spikes and the respective dependent baseline parameters, and alerted the cloud computing platform provider in advance of the onset of significant resource-intensive consequences (e.g., before the end user observes the issue(s)), maintaining and/or enhancing the overall user experience.

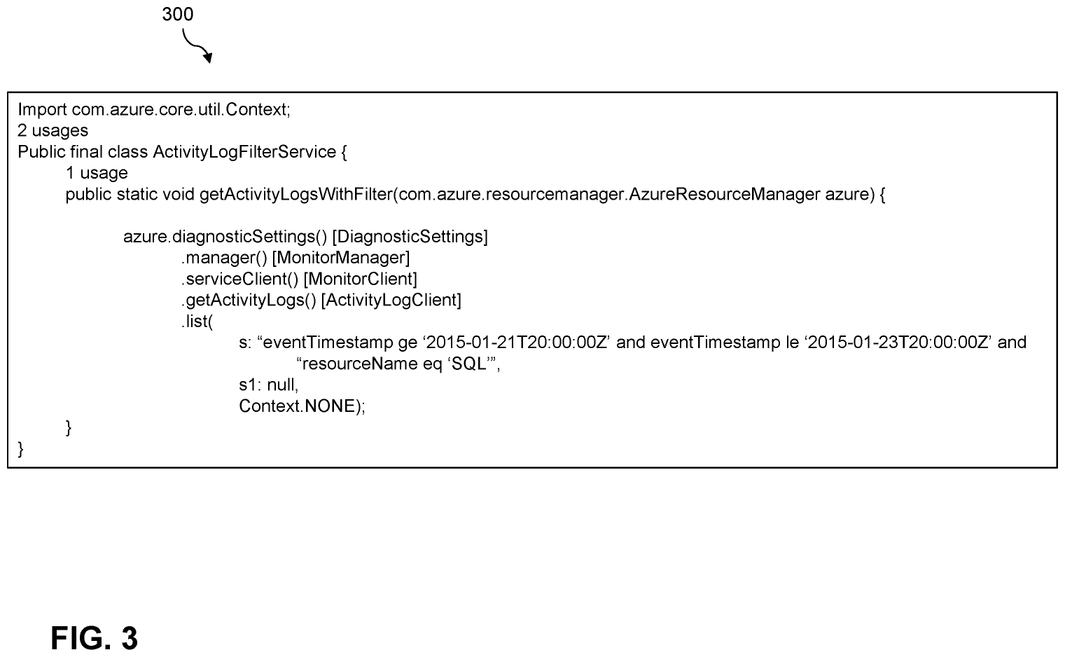

FIG. 3 shows example pseudocode for extracting data from activity logs in an illustrative embodiment. In this embodiment, example pseudocode 300 is executed by or under the control of at least one processing system and/or device. For example, the example pseudocode 300 may be viewed as comprising a portion of a software implementation of at least part of cloud computing platform-related anomaly detection system 105 of the FIG. 1 embodiment.

The example pseudocode 300 illustrates importing one or more services libraries in conjunction with implementing an activity log filter service. Such a service is then utilized to obtain activity logs within the context of one or more timestamps, including monitoring entities such as managers and clients.

It is to be appreciated that this particular example pseudocode shows just one example implementation of extracting data from activity logs, and alternative implementations can be used in other embodiments.

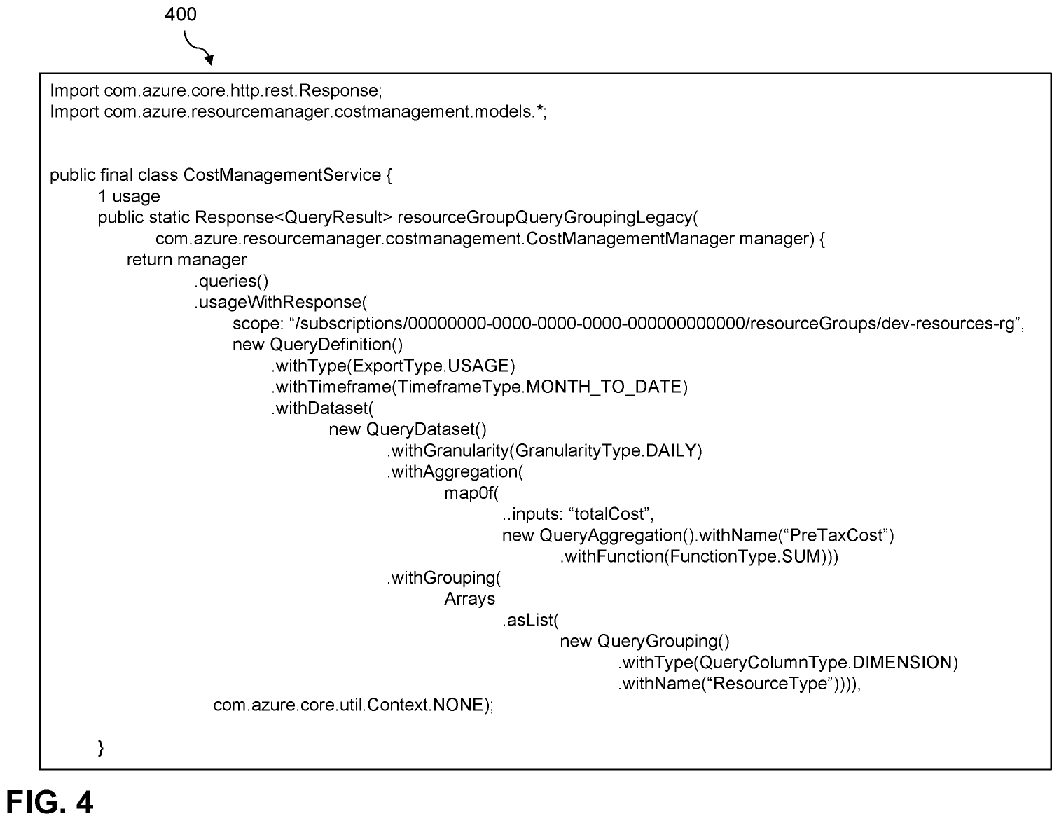

FIG. 4 shows example pseudocode for fetching cloud computing platform resource-related value details in an illustrative embodiment. In this embodiment, example pseudocode 400 is executed by or under the control of at least one processing system and/or device. For example, the example pseudocode 400 may be viewed as comprising a portion of a software implementation of at least part of cloud computing platform-related anomaly detection system 105 of the FIG. 1 embodiment.

The example pseudocode 400 illustrates fetching cloud computing platform resource-related value details such as, for example, fetching daily cost billing details for each of one or more cloud computing platform resource types. Additionally, example pseudocode 400 illustrates returning values and/or information for pre-tax cost value, resource type, usage date, and currency for the resources under the resource group in a given subscription.

It is to be appreciated that this particular example pseudocode shows just one example implementation of fetching cloud computing platform resource-related value details, and alternative implementations can be used in other embodiments.

FIG. 5 is a flow diagram of a process for automatically detecting cloud computing platform-related anomalies in an illustrative embodiment. It is to be understood that this particular process is only an example, and additional or alternative processes can be carried out in other embodiments.

In this embodiment, the process includes steps 500 through 506. These steps are assumed to be performed by the cloud computing platform-related anomaly detection system 105 utilizing elements 112, 114 and 116.

Step 500 includes identifying a modification to at least one resource-related value associated with a cloud computing platform by processing data related to the at least one resource-related value in connection with at least one temporal period. In at least one embodiment, identifying a modification to at least one resource-related value associated with a cloud computing platform includes identifying a cost increase associated with at least one given cloud computing platform resource. In such an embodiment, identifying a cost increase associated with at least one given cloud computing platform resource can include identifying a cost increase associated with at least one of API management services offered in connection with the cloud computing platform, a serverless structured query language database offered in connection with the cloud computing platform, and an application monitoring service offered in connection with the cloud computing platform.

Additionally, in at least one embodiment, identifying a modification to at least one resource-related value associated with a cloud computing platform includes identifying a modification to the at least one resource-related value which exceeds a predetermined threshold value. Further, processing data related to the at least one resource-related value in connection with at least one temporal period can include monitoring, using at least one cloud-related monitoring tool, data related to the at least one resource-related value in real-time.

Step 502 includes processing multiple forms of cloud computing platform-related parameter data in connection with the at least one temporal period. In one or more embodiments, processing multiple forms of cloud computing platform-related parameter data includes processing two or more of application deployment-related data, incoming request volume-related data, and cloud computing platform resource configuration-related data.

Step 504 includes determining, based at least in part on the processing of the multiple forms of cloud computing platform-related parameter data, that no related modification corresponding to the identified modification to the at least one resource-related value has occurred in the at least one temporal period with respect to one or more cloud computing platform-related parameters associated with the multiple forms of cloud computing platform-related parameter data. In at least one embodiment,

Step 506 includes performing one or more automated actions based at least in part on determining that no related modification corresponding to the identified modification to the at least one resource-related value has occurred in the at least one temporal period with respect to the one or more cloud computing platform-related parameters. In one or more embodiments, performing one or more automated actions includes automatically detecting at least one cloud computing platform-related anomaly based at least in part on determining that no related modification corresponding to the identified modification to the at least one resource-related value has occurred in the at least one temporal period with respect to the one or more cloud computing platform-related parameters. Such an embodiment can also include automatically initiating remediation of the at least one cloud computing platform-related anomaly by modifying one or more cloud computing platform resources.

Additionally or alternatively, performing one or more automated actions can include proactively updating billing information with respect to one or more users of the cloud computing platform in connection with the identified modification to the at least one resource-related value. Also, in at least one embodiment, performing one or more automated actions can include automatically generating and outputting, to at least one provider of the cloud computing platform, an alert comprising information pertaining to the identified modification to the at least one resource-related value and lack of corresponding modification to the one or more cloud computing platform-related parameters. In such an embodiment, generating and outputting an alert can include generating and outputting an alert comprising resource details related to the identified modification to the at least one resource-related value and historical audit data of the one or more cloud computing platform-related parameters.

Accordingly, the particular processing operations and other functionality described in conjunction with the flow diagram of FIG. 5 are presented by way of illustrative example only, and should not be construed as limiting the scope of the disclosure in any way. For example, the ordering of the process steps may be varied in other embodiments, or certain steps may be performed concurrently with one another rather than serially.

The above-described illustrative embodiments provide significant advantages relative to conventional approaches. For example, some embodiments are configured to automatically detect one or more cloud computing platform-related anomalies. These and other embodiments can effectively overcome problems associated with reactive cloud computing platform management approaches.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

As mentioned previously, at least portions of the information processing system 100 can be implemented using one or more processing platforms. A given processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform used to implement at least a portion of an information processing system comprises cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components, or portions thereof, are illustratively implemented for use by tenants of such a multi-tenant environment.

As mentioned previously, cloud infrastructure as disclosed herein can include cloud-based systems. Virtual machines provided in such systems can be used to implement at least portions of a computer system in illustrative embodiments.

In some embodiments, the cloud infrastructure additionally or alternatively comprises a plurality of containers implemented using container host devices. For example, as detailed herein, a given container of cloud infrastructure illustratively comprises a Docker container or other type of Linux Container (LXC). The containers are run on virtual machines in a multi-tenant environment, although other arrangements are possible. The containers are utilized to implement a variety of different types of functionality within the system 100. For example, containers can be used to implement respective processing devices providing compute and/or storage services of a cloud-based system. Again, containers may be used in combination with other virtualization infrastructure such as virtual machines implemented using a hypervisor.

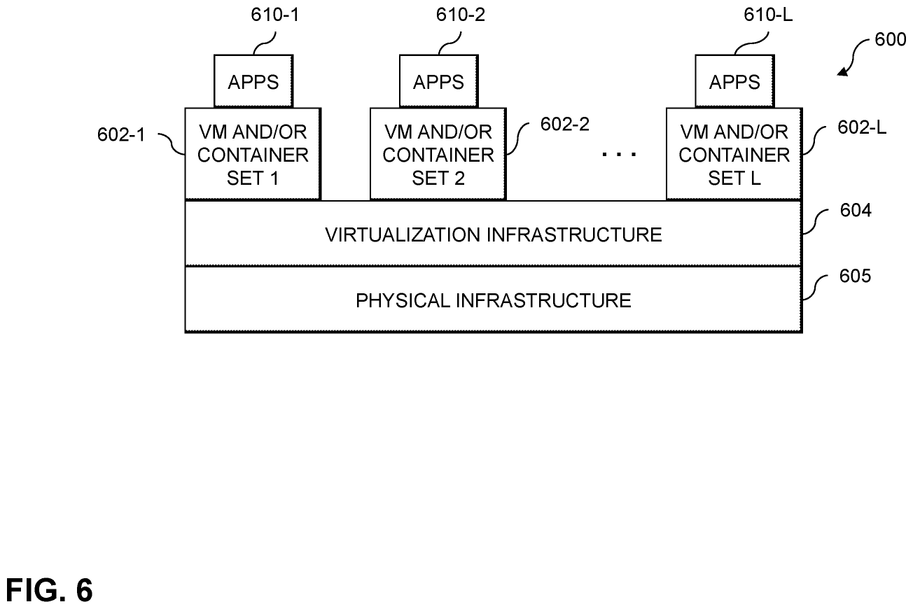

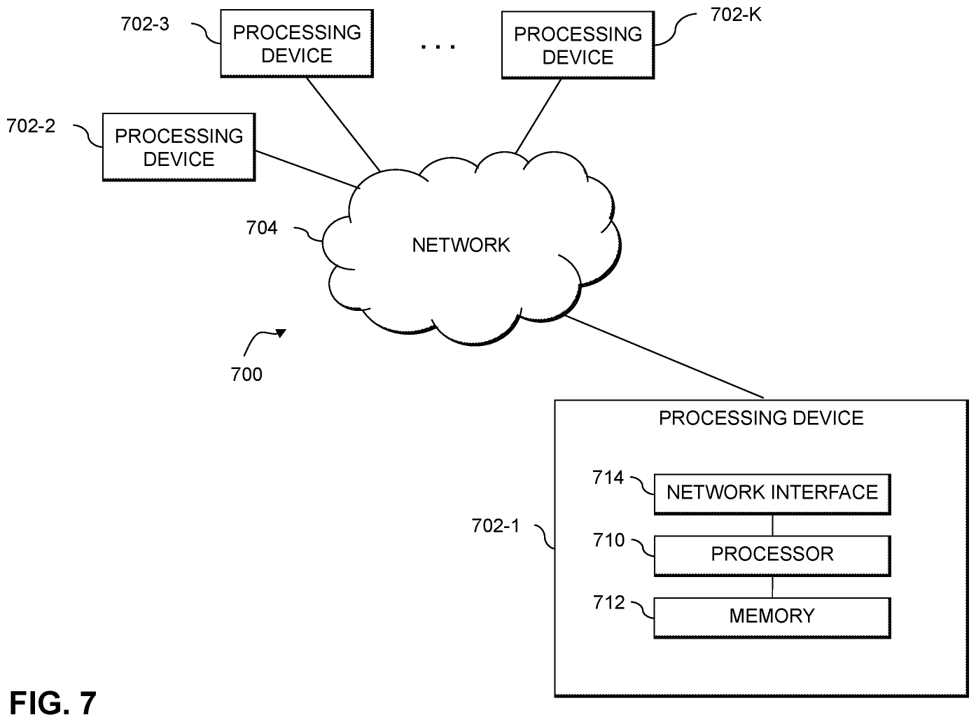

Illustrative embodiments of processing platforms will now be described in greater detail with reference to FIGS. 6 and 7. Although described in the context of system 100, these platforms may also be used to implement at least portions of other information processing systems in other embodiments.

FIG. 6 shows an example processing platform comprising cloud infrastructure 600. The cloud infrastructure 600 comprises a combination of physical and virtual processing resources that are utilized to implement at least a portion of the information processing system 100. The cloud infrastructure 600 comprises multiple virtual machines (VMs) and/or container sets 602-1, 602-2, . . . 602-L implemented using virtualization infrastructure 604. The virtualization infrastructure 604 runs on physical infrastructure 605, and illustratively comprises one or more hypervisors and/or operating system level virtualization infrastructure. The operating system level virtualization infrastructure illustratively comprises kernel control groups of a Linux operating system or other type of operating system.

The cloud infrastructure 600 further comprises sets of applications 610-1, 610-2, . . . 610-L running on respective ones of the VMs/container sets 602-1, 602-2, . . . 602-L under the control of the virtualization infrastructure 604. The VMs/container sets 602 comprise respective VMs, respective sets of one or more containers, or respective sets of one or more containers running in VMs. In some implementations of the FIG. 6 embodiment, the VMs/container sets 602 comprise respective VMs implemented using virtualization infrastructure 604 that comprises at least one hypervisor.

A hypervisor platform may be used to implement a hypervisor within the virtualization infrastructure 604, wherein the hypervisor platform has an associated virtual infrastructure management system. The underlying physical machines comprise one or more information processing platforms that include one or more storage systems.

In other implementations of the FIG. 6 embodiment, the VMs/container sets 602 comprise respective containers implemented using virtualization infrastructure 604 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element is viewed as an example of what is more generally referred to herein as a “processing device.” The cloud infrastructure 600 shown in FIG. 6 may represent at least a portion of one processing platform. Another example of such a processing platform is processing platform 700 shown in FIG. 7.

The processing platform 700 in this embodiment comprises a portion of system 100 and includes a plurality of processing devices, denoted 702-1, 702-2, 702-3, . . . 702-K, which communicate with one another over a network 704.

The network 704 comprises any type of network, including by way of example a global computer network such as the Internet, a WAN, a LAN, a satellite network, a telephone or cable network, a cellular network, a wireless network such as a Wi-Fi or WiMAX network, or various portions or combinations of these and other types of networks.

The processing device 702-1 in the processing platform 700 comprises a processor 710 coupled to a memory 712.

The processor 710 comprises a microprocessor, a CPU, a GPU, a TPU, a microcontroller, an ASIC, a FPGA or other type of processing circuitry, as well as portions or combinations of such circuitry elements.

The memory 712 comprises random access memory (RAM), read-only memory (ROM) or other types of memory, in any combination. The memory 712 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture comprises, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 702-1 is network interface circuitry 714, which is used to interface the processing device with the network 704 and other system components, and may comprise conventional transceivers.

The other processing devices 702 of the processing platform 700 are assumed to be configured in a manner similar to that shown for processing device 702-1 in the figure.

Again, the particular processing platform 700 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage products or devices, or other components are possible in the information processing system 100. Such components can communicate with other elements of the information processing system 100 over any type of network or other communication media.

For example, particular types of storage products that can be used in implementing a given storage system of an information processing system in an illustrative embodiment include all-flash and hybrid flash storage arrays, scale-out all-flash storage arrays, scale-out NAS clusters, or other types of storage arrays. Combinations of multiple ones of these and other storage products can also be used in implementing a given storage system in an illustrative embodiment.

It should again be emphasized that the above-described embodiments are presented for purposes of illustration only. Many variations and other alternative embodiments may be used. Also, the particular configurations of system and device elements and associated processing operations illustratively shown in the drawings can be varied in other embodiments. Thus, for example, the particular types of processing devices, modules, systems and resources deployed in a given embodiment and their respective configurations may be varied. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A computer-implemented method comprising:
identifying a modification to at least one resource-related value associated with a cloud computing platform by processing data related to the at least one resource-related value in connection with at least one temporal period;
processing multiple forms of cloud computing platform-related parameter data in connection with the at least one temporal period;
determining, based at least in part on the processing of the multiple forms of cloud computing platform-related parameter data, that no related modification corresponding to the identified modification to the at least one resource-related value has occurred in the at least one temporal period with respect to one or more cloud computing platform-related parameters associated with the multiple forms of cloud computing platform-related parameter data; and
performing one or more automated actions based at least in part on determining that no related modification corresponding to the identified modification to the at least one resource-related value has occurred in the at least one temporal period with respect to the one or more cloud computing platform-related parameters;
wherein the method is performed by at least one processing device comprising a processor coupled to a memory.

2. The computer-implemented method of claim 1, wherein performing one or more automated actions comprises automatically detecting at least one cloud computing platform-related anomaly based at least in part on determining that no related modification corresponding to the identified modification to the at least one resource-related value has occurred in the at least one temporal period with respect to the one or more cloud computing platform-related parameters.

3. The computer-implemented method of claim 2, further comprising:
automatically initiating remediation of the at least one cloud computing platform-related anomaly by modifying one or more cloud computing platform resources.

4. The computer-implemented method of claim 1, wherein performing one or more automated actions comprises proactively updating billing information with respect to one or more users of the cloud computing platform in connection with the identified modification to the at least one resource-related value.

5. The computer-implemented method of claim 1, wherein processing multiple forms of cloud computing platform-related parameter data comprises processing two or more of application deployment-related data, incoming request volume-related data, and cloud computing platform resource configuration-related data.

6. The computer-implemented method of claim 1, wherein identifying a modification to at least one resource-related value associated with a cloud computing platform comprises identifying a cost increase associated with at least one given cloud computing platform resource.

7. The computer-implemented method of claim 6, wherein identifying a cost increase associated with at least one given cloud computing platform resource comprises identifying a cost increase associated with at least one of application programming interface management services offered in connection with the cloud computing platform, a serverless structured query language database offered in connection with the cloud computing platform, and an application monitoring service offered in connection with the cloud computing platform.

8. The computer-implemented method of claim 1, wherein processing data related to the at least one resource-related value in connection with at least one temporal period comprises monitoring, using at least one cloud-related monitoring tool, data related to the at least one resource-related value in real-time.

9. The computer-implemented method of claim 1, wherein identifying a modification to at least one resource-related value associated with a cloud computing platform comprises identifying a modification to the at least one resource-related value which exceeds a predetermined threshold value.

10. The computer-implemented method of claim 1, wherein performing one or more automated actions comprises automatically generating and outputting, to at least one provider of the cloud computing platform, an alert comprising information pertaining to the identified modification to the at least one resource-related value and lack of corresponding modification to the one or more cloud computing platform-related parameters.

11. The computer-implemented method of claim 10, wherein generating and outputting an alert comprises generating and outputting an alert comprising resource details related to the identified modification to the at least one resource-related value and historical audit data of the one or more cloud computing platform-related parameters.

12. A non-transitory processor-readable storage medium having stored therein program code of one or more software programs, wherein the program code when executed by at least one processing device causes the at least one processing device:
to identify a modification to at least one resource-related value associated with a cloud computing platform by processing data related to the at least one resource-related value in connection with at least one temporal period;
to process multiple forms of cloud computing platform-related parameter data in connection with the at least one temporal period;
to determine, based at least in part on the processing of the multiple forms of cloud computing platform-related parameter data, that no related modification corresponding to the identified modification to the at least one resource-related value has occurred in the at least one temporal period with respect to one or more cloud computing platform-related parameters associated with the multiple forms of cloud computing platform-related parameter data; and
to perform one or more automated actions based at least in part on determining that no related modification corresponding to the identified modification to the at least one resource-related value has occurred in the at least one temporal period with respect to the one or more cloud computing platform-related parameters.

13. The non-transitory processor-readable storage medium of claim 12, wherein performing one or more automated actions comprises automatically detecting at least one cloud computing platform-related anomaly based at least in part on determining that no related modification corresponding to the identified modification to the at least one resource-related value has occurred in the at least one temporal period with respect to the one or more cloud computing platform-related parameters.

14. The non-transitory processor-readable storage medium of claim 13, wherein the program code when executed by the at least one processing device causes the at least one processing device:
to automatically initiate remediation of the at least one cloud computing platform-related anomaly by modifying one or more cloud computing platform resources.

15. The non-transitory processor-readable storage medium of claim 12, wherein processing multiple forms of cloud computing platform-related parameter data comprises processing two or more of application deployment-related data, incoming request volume-related data, and cloud computing platform resource configuration-related data.

16. The non-transitory processor-readable storage medium of claim 12, wherein identifying a modification to at least one resource-related value associated with a cloud computing platform comprises identifying a cost increase associated with at least one given cloud computing platform resource.

17. An apparatus comprising:
at least one processing device comprising a processor coupled to a memory;
the at least one processing device being configured:
to identify a modification to at least one resource-related value associated with a cloud computing platform by processing data related to the at least one resource-related value in connection with at least one temporal period;
to process multiple forms of cloud computing platform-related parameter data in connection with the at least one temporal period;
to determine, based at least in part on the processing of the multiple forms of cloud computing platform-related parameter data, that no related modification corresponding to the identified modification to the at least one resource-related value has occurred in the at least one temporal period with respect to one or more cloud computing platform-related parameters associated with the multiple forms of cloud computing platform-related parameter data; and
to perform one or more automated actions based at least in part on determining that no related modification corresponding to the identified modification to the at least one resource-related value has occurred in the at least one temporal period with respect to the one or more cloud computing platform-related parameters.

18. The apparatus of claim 17, wherein performing one or more automated actions comprises automatically detecting at least one cloud computing platform-related anomaly based at least in part on determining that no related modification corresponding to the identified modification to the at least one resource-related value has occurred in the at least one temporal period with respect to the one or more cloud computing platform-related parameters.

19. The apparatus of claim 18, wherein the at least one processing device is further configured:
to automatically initiate remediation of the at least one cloud computing platform-related anomaly by modifying one or more cloud computing platform resources.

20. The apparatus of claim 17, wherein processing multiple forms of cloud computing platform-related parameter data comprises processing two or more of application deployment-related data, incoming request volume-related data, and cloud computing platform resource configuration-related data.
